(19) United States
(12) Patent Application Publication
(10) Pub. No.: US 2025/0283378 A1
(43) Pub. Date: Sep. 11, 2025

(54) LADDER WITH LIFTING AND LOWERING HANDRAIL

(71) Applicant: Luhao Leng, Xiamen (CN)

(72) Inventor: Luhao Leng, Xiamen (CN)

(21) Appl. No.: 19/071,821

(22) Filed: Mar. 6, 2025

(30) Foreign Application Priority Data
Mar. 11, 2024 (CN) 202420466228.9

(51) Int. Cl. E06C 7/18; E06C 1/20; E06C 7/50

(52) U.S. Cl. CPC E06C 7/182; E06C 1/20; E06C 7/50

(57) ABSTRACT

A ladder with a lifting and lowering handrail includes a ladder body and a handrail frame configured to be lifted and lowered on the ladder body. Two front leg tubes and two rear leg tubes are pivotally connected to form a foldable structure. The handrail frame includes a lateral rod and two side rods. Two pivoting sleeves respectively cover tops of the two front leg tubes. Tops of the two rear leg tubes are pivotally connected to the two pivoting sleeves. C-shaped openings of the two side rods are located on inner sides of the two side rods and cover outer sides of the two front leg tubes. The two side rods are configured to slide on the two pivoting sleeves. A lower end of at least one of the two side rods is disposed with a locking device configured to control the handrail frame to be lifted and lowered.

### RELATED APPLICATIONS

This application claims priority to Chinese patent application number 202420466228.9, filed on Mar. 11, 2024. Chinese patent application number 202420466228.9 is incorporated herein by reference.

### FIELD OF THE DISCLOSURE

The present disclosure relates to a folding ladder and in particular to a ladder with a lifting and lowering handrail.

### BACKGROUND OF THE DISCLOSURE

Folding ladders have the advantages of being lightweight and easy to store, making them a common household tool sold in large supermarkets. Depending on whether the ladder has handrails, they are generally divided into two types: one type is the V-shaped ladder without handrails, and the other type is the inverted Y-shaped ladder with handrails. Handrails serve a protective role and help users stand more steadily on the highest step.

However, most existing handrails are directly fixed to leg tubes of the ladder, either as a one-piece structure, a welded structure, or a bolt-secured structure. That is, the handrail is a fixed structure, which, while considering convenience for storage, results in the handrail being relatively low in height. When a person is on the highest step of the ladder, the handrail may not be very practical due to its limited height. Furthermore, the fixed nature of the handrail limits the storage space, which can negatively affect normal use of the ladder.

### BRIEF SUMMARY OF THE DISCLOSURE

The technical problem to be solved by the present disclosure is to provide a ladder with a lifting and lowering handrail.

In order to solve the above technical problems, the present disclosure provides the ladder with the lifting and lowering handrail. The ladder comprises a ladder body and a handrail frame sleeve on the ladder body and configured to be lifted and lowered. The ladder body comprises two front leg tubes, two rear leg tubes, and two pivoting sleeves, and the two front leg tubes and the two rear leg tubes are pivotally connected to form a foldable inverted Y-shaped structure. The handrail frame comprises a lateral rod and two side rods symmetrically arranged on a left and right direction, and upper ends of the two side rods are connected to two ends of the lateral rod. The two pivoting sleeves respectively cover tops of the two front leg tubes, and tops of the two rear leg tubes are respectively pivotally connected to the two pivoting sleeves. Cross sections of the two side rods are C-shaped cross sections, and C-shaped openings of the C-shaped cross sections are located on inner sides of the two side rods. The C-shaped openings of the two side rods cover outer sides of the two front leg tubes, and the two pivoting sleeves comprise position-providing grooves. The two side rods are configured to slide on the position-providing grooves, and a lower end of at least one of the two side rods is disposed with a locking device. The locking device is configured to be a lifting-and-lowering adjusting switch for controlling the handrail frame to be lifted and lowered.

In a preferred embodiment, an upper end surface of each of the two pivoting sleeves comprises a step surface, and outer sides of the two pivoting sleeves comprise the position-providing grooves. When the handrail frame is retracted, the lateral rod abuts the step surface.

In a preferred embodiment, each of the two pivoting sleeves comprises a first sleeve and a second sleeve, and the first sleeve is sleeved on a corresponding one of the two front leg tubes. The second sleeve is sleeved on a corresponding one of the two rear leg tubes, and the second sleeve comprises a space for the corresponding one of the two rear leg tubes to rotate.

In a preferred embodiment, the corresponding one of the two rear leg tubes is rotatably connected in the second sleeve through a rivet.

In a preferred embodiment, the locking device comprises a hand-held sleeve sleeved on the lower end of the at least one of the two side rods, a button pivotally connected to the hand-held sleeve, at least one locking hole arranged on a side of a corresponding one of the two front leg tubes, and a locking head disposed on the button and configured to correspond to the at least one locking hole. The locking head is configured to be disposed in or separated from the at least one locking hole driven by the button.

In a preferred embodiment, the hand-held sleeve is buckled to the at least one of the two side rods, and a middle part of the button is pivotally connected to the hand-held sleeve. The button is located on a rear side of the hand-held sleeve, and the locking head is disposed on an inner side of a lower end of the button. An elastic member is disposed on an inner side of an upper end of the button, and the locking head is configured to be disposed in the at least one locking hole driven by the elastic member.

In a preferred embodiment, a part of the button that forms the locking head extends out of the hand-held sleeve and forms an interlocked connection with the at least one locking hole on the corresponding one of the two front leg tubes.

In a preferred embodiment, the at least one locking hole is at least one rectangular hole, and the locking head is a protruding surface. The locking head comprises a protruding part and two buckling edges, and the two buckling edges are buckled in the button. The protruding part is disposed outside the button and is configured to be disposed in the at least one rectangular hole.

In a preferred embodiment, the at least one locking hole is a plurality of locking holes, and the plurality of locking holes are spaced apart along a length direction of the corresponding one of the two front leg tubes.

In a preferred embodiment, the handrail frame is U-shaped, and the lower end of each of the two side rods is disposed with the locking device.

Compared with the existing techniques, the technical solution has the following advantages.
1. The two front leg tubes and the two rear leg tubes are connected through two pivoting sleeves. Cross-sections at connection ends of the two front leg tubes and the two front leg tubes lie in a same plane, making an overall ladder look simple, reliable, and aesthetically pleasing.
2. The ladder body is disposed with the lifting and lowering handrail, allowing the ladder to have the handrail frame while still being foldable for storage. The lifting and lowering handrail can also meet the needs of different heights for handrail use, enhancing functionality.
3. The at least one rectangular hole, combined with a locking head with a protruding surface, is more stable than a conventional round locking hole. The at least one rectangular hole can better lock the locking head, forming a more stable locking structure, avoiding a problem of the locking device coming off, and improving the ladder's safety during use.

### BRIEF DESCRIPTION OF THE DRAWINGS

FIG. 1 is a perspective view of a ladder in a use state in a preferred embodiment of the present disclosure.

FIG. 2 is a perspective view of the ladder, including a cross-sectional view on a pivoting sleeve of the ladder in the preferred embodiment of the present disclosure.

FIG. 3 is an enlarged view of section A in FIG. 1.

FIG. 4 is an enlarged view of section B in FIG. 2.

FIG. 5 is a perspective view of part of the ladder, including a cross-sectional view of a locking device in the preferred embodiment of the present disclosure.

FIG. 6 is a perspective view of a locking hole and a locking head being inserted into each other in the preferred embodiment of the present disclosure.

FIG. 7 is a perspective view of the locking hole in the preferred embodiment of the present disclosure.

Explanation of the reference numerals: 1. ladder; 11. front leg tube; 111. locking hole; 12. rear leg tube; 13. pivoting sleeve; 131. Position-providing groove; 132. first sleeve; 133. second sleeve; 134. rivet; 135. step surface; 2. handrail frame; 21. lateral rod; 22. side rod; 3. locking device; 31. hand-held sleeve; 32. button; 33. locking head; and 34. elastic member.

### DETAILED DESCRIPTION OF THE EMBODIMENTS

The technical solutions of the embodiments of the present disclosure will be described in detail below with reference to the drawings. It should be understood that the embodiments described are only part of the embodiments of the present disclosure, and not all possible embodiments. All other embodiments that would be apparent to a person skilled in the art based on the teachings of the present disclosure, without requiring any inventive step, are within the scope of the present disclosure's protection.

In the description of the present disclosure, it should be noted that terms such as “upper”, “lower”, “inner”, “outer”, “top end”, “bottom end”, and the like, refer to positions or positional relationships based on the orientations shown in the drawings. These terms are used for convenience in describing the present disclosure and simplifying the description, and should not be interpreted as limiting the present disclosure. The device or element in question does not necessarily have to be constructed or operated in a specific orientation or position. Additionally, the terms “first”, “second”, and similar terms are used for descriptive purposes only and do not imply any relative importance or ranking.

In the description of the present disclosure, unless otherwise clearly stated or limited, terms such as “installed”, “provided with”, “sleeved on”, “connected”, etc., should be understood in their broadest sense. For example, “connection” can refer to a wall-mounted connection, a detachable connection, or an integral connection. It may refer to a mechanical or electrical connection, direct or indirect connection, or an internal connection between components. The specific meaning of these terms will be understood by those skilled in the art based on the particular context of the disclosure.

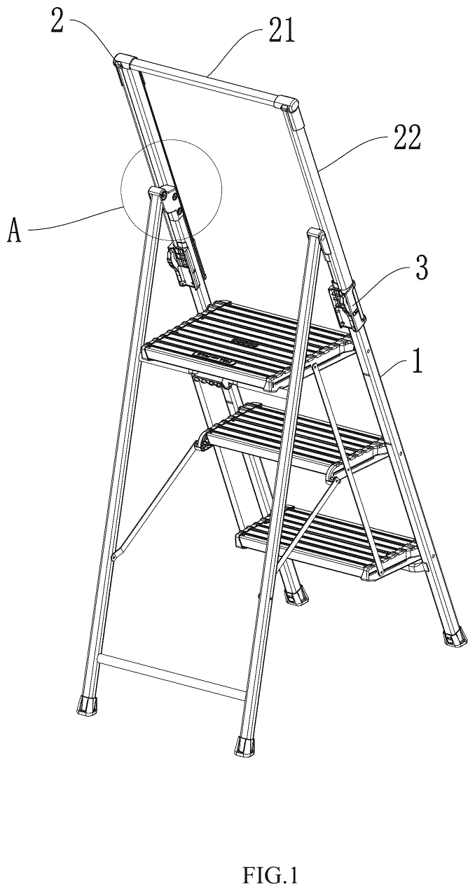

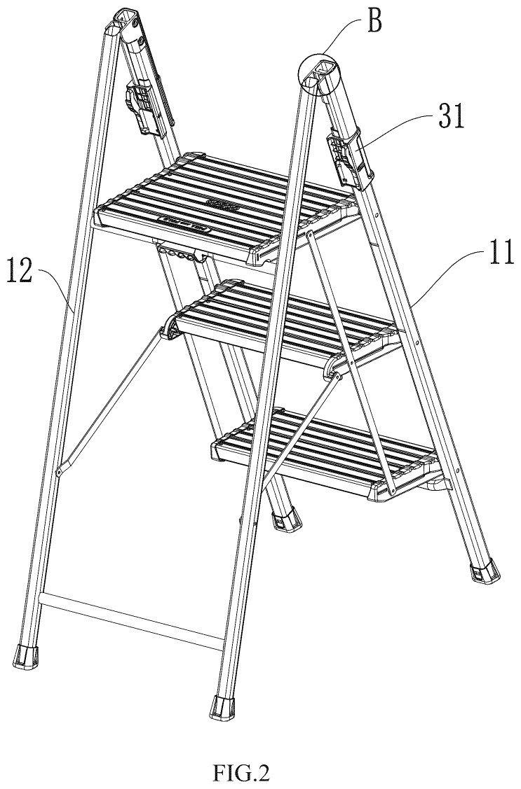

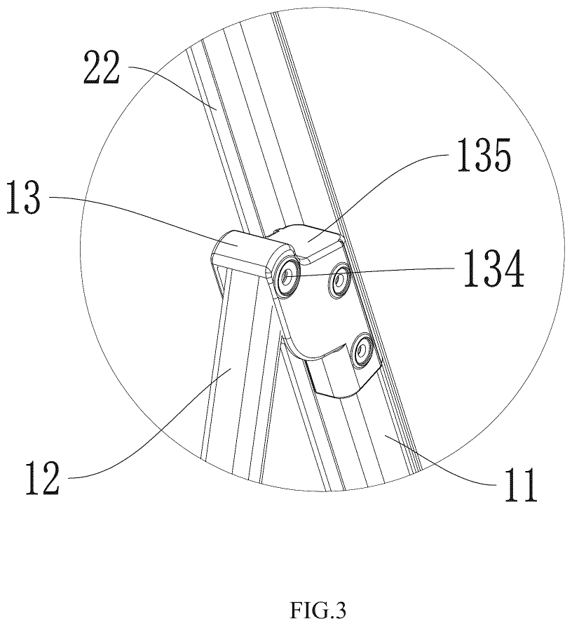

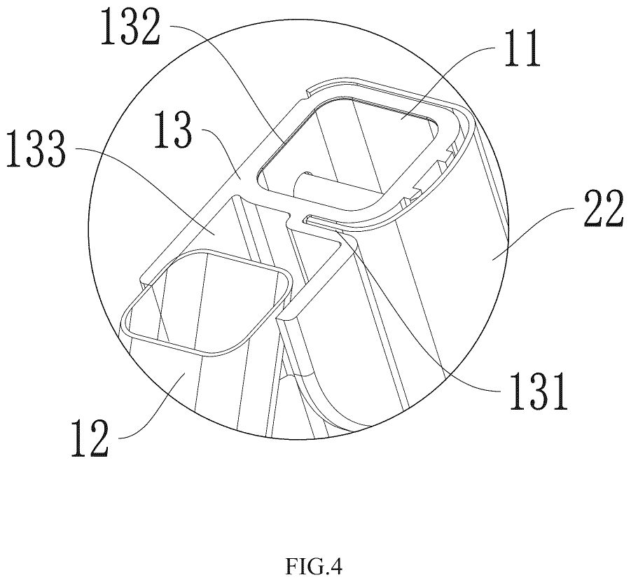

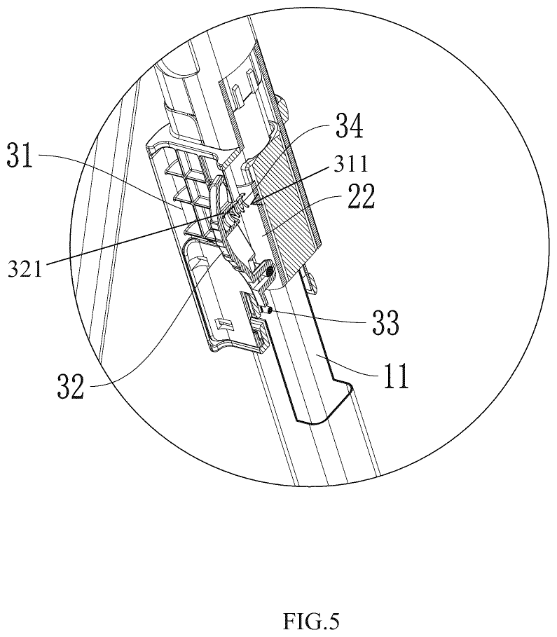

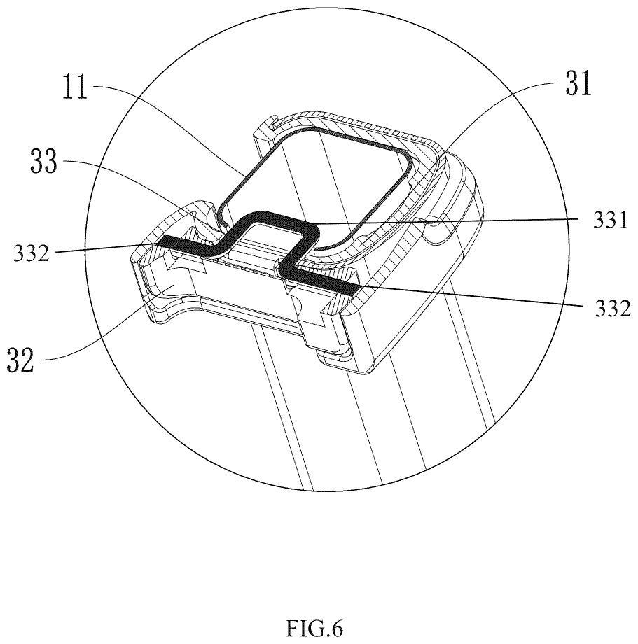

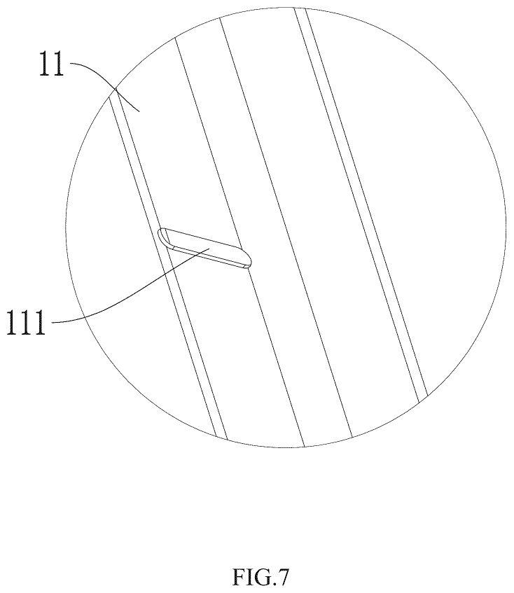

Referring to FIG. 1 to FIG. 7, the present embodiment provides a ladder 1 with a lifting and lowering handrail. The ladder 1 comprises two front leg tubes 11, two rear leg tubes 12, and two pivoting sleeves 13. The two front leg tubes 11 and the two rear leg tubes 12 are pivotally connected to form a foldable inverted Y-shaped structure. The two pivoting sleeves 13 respectively cover tops of the two front leg tubes 11, and tops of the two rear leg tubes 12 are respectively pivotally connected to the two pivoting sleeves 13. Specifically, an upper end surface of each of the two pivoting sleeves 13 is a flat surface. Each of the two pivoting sleeves 13 comprises a first sleeve 132 and a second sleeve 133. The first sleeve 132 is sleeved on a corresponding one of the two front leg tubes 11, and the second sleeve 133 is sleeved on a corresponding one of the two rear leg tubes 12. The corresponding one of the two rear leg tubes 12 is pivotally connected in the second sleeve 133 through a rivet 134, and the second sleeve 133 comprises a space for the corresponding one of the two rear leg tubes 12 to rotate. The two front leg tubes 11 and the two rear leg tubes 12 are folded and unfolded by using the two pivoting sleeves 13, so that a connection between the two front leg tubes 11 and the two rear leg tubes 12 is more stable and unfolding and folding of the ladder 1 is more convenient. At the same time, the upper end surface, which is flat, of each of the two pivoting sleeves 13 is convenient for supporting the ladder 1, and is beautiful and neat.

A handrail frame 2 is U-shaped, and the handrail frame 2 comprises a lateral rod 21 and two side rods 22 symmetrically arranged in a left and right direction. Upper ends of the two side rods 22 are connected to two ends of the lateral rod 21. Cross sections of the two side rods 22 are C-shaped cross sections, and C-shaped openings of the C-shaped cross sections are located on inner sides of the two side rods 22. The inner sides refer to opposite surfaces of the two side rods 22 facing an inside of the ladder 1. The C-shaped openings of the two side rods 22 cover outer sides of the two front leg tubes 11. Outer sides of the two pivoting sleeves 13 comprise position-providing grooves 131, and the two side rods 22 are configured to slide on the position-providing grooves 131. The C-shaped openings of the two side rods 22 can provide a space for the two side rods 22 and the two pivoting sleeves 13 and avoid interference between the handrail frame 2 and the two pivoting sleeves 13 during a lifting and lowering process. The C-shaped openings of the two side rods 22 cover the outer sides of the two front leg tubes 11, so that the handrail frame 2 can be more stable during sliding and convenient for disassembly and assembly. The ladder 1 looks simple and reliable as a whole.

To make the ladder 1 and the handrail frame 2 more beautiful as a whole after being folded, the upper end surface of each of the two pivoting sleeves 13 comprises a step surface 135, and an upper end protrusion of the second sleeve 133 on which the rear leg tube 12 is installed is higher than the step surface 135. When the handrail frame 2 is retracted, the lateral rod 21 abuts the step surface 135, and an upper end surface of the lateral rod 21 is exactly flush with the upper end protrusion of the second sleeve 133, forming a flat structure, so that the ladder 1 is more neat and simple as a whole after being folded.

To effectively perform locking of the handrail frame 2 after being lifted and lowered, a lower end of each of the two side rods 22 is disposed with a locking device 3, and the locking device 3 is configured to be a telescopic adjusting switch for controlling the handrail frame 2 to be lifted and lowered. The locking devices 3 are disposed on two sides of the ladder 1 to make the locking of the handrail frame 2 after being lifted and lowered more stable and firm.

The locking device 3 comprises a hand-held sleeve 31 sleeved on the lower end of a corresponding one of the two side rods 22, a button 32 pivotally connected to the hand-held sleeve 31, at least one locking hole 111 arranged on a side of the corresponding one of the two front leg tubes 11, and a locking head 33 disposed on the button 32 and configured to correspond to the at least one locking hole 111. The locking head 33 can be inserted into or removed from the at least one locking hole 111 driven by the button 32.

A middle part of the button 32 is pivotally connected to the hand-held sleeve 31, and the locking head 33 is disposed on an inner side of a lower end of the button 32. An elastic member 34 is disposed on an inner side of an upper end of the button 32. The locking head 33 can be inserted into the at least one locking hole 111 driven by the elastic member 34.

When in use, the locking head 33 is inserted into the at least one locking hole 111 of the corresponding one of the two front leg tubes 11 driven by the elastic member 34, so that the two side rods 22 of the handrail frame 2 and the two front leg tubes 11 of the ladder 1 are interlocked with each other, so as to achieve a purpose of fixing the handrail frame 2. When a height of the handrail frame 2 needs to be adjusted, the button 32 is pressed, and the upper end of the button 32 presses the elastic member 34 to enable the lower end of the button 32 to rotate and tilt up, so that the locking head 33 can be separated from the at least one locking hole 111, thereby releasing the interlocking connection of the handrail frame 2, and the handrail frame 2 can be lifted and lowered.

To allow the handrail frame 2 to have different height adjustments, the least one locking hole 111 is a plurality of locking holes 111 arranged on the side of the corresponding one of the two front leg tubes 11. The plurality of locking holes 111 are spaced apart along a length direction of the corresponding one of the two front leg tubes 11. The plurality of locking holes 111 enable the handrail frame 2 to have a function of different height adjustment. The handrail frame 2 can be quickly lowered when stored, and the height of the handrail frame 2 can be adjusted according to requirements of a user when in use, thereby improving safety of the ladder 1. The hand-held sleeve 31 is buckled to the corresponding one of the two side rods 22, and the button 32 is disposed at a rear side of the corresponding one of the two side rods 22. In this way, while the hand-held sleeve 31 is held and the button 32 is pressed, the handrail frame 2 can be better held for lifting and lowering adjustment.

To simplify a locking structure of the locking head 33 and the at least one locking hole 111, a part of the button 32 that forms the locking head 33 extends out of the hand-held sleeve 31 and forms an interlocked connection with the at least one locking hole 111 on the corresponding one of the two front leg tubes 11. The part of the button 32 that forms the locking head 33 is directly interlocked with the at least one locking hole 111 on the corresponding one of the two front leg tubes 11, and an operation of pressing the button 32 can be more flexible and more convenient. In addition, when designing the structure, it is only necessary to provide the at least one locking hole 111 of the corresponding one of the two front leg tubes 11, and there is no need to provide an avoidance hole on the hand-held sleeve 31 and the corresponding one of the two side rods 22. The structure is more concise, and the locking head 33 is simpler to be inserted into the at least one locking hole 111. There is no need for multi-hole alignment (i.e., in which the avoidance hole needs to be aligned with the at least one locking hole 111), which can avoid a phenomenon in which the locking head 33 falls out and cannot be locked due to the multi-hole alignment.

To facilitate the operation of pressing the button 32, the elastic member 34 is configured as a spring. A position of the button 32 corresponding to the elastic member 34 is disposed with a positioning pin 321, and a position of the hand-held sleeve 31 corresponding to the elastic member 34 comprises a mounting hole 311. A first end of the elastic member 34 is fixed in the mounting hole 311, and a second end of the elastic member 34 is inserted into the positioning pin 321. Movement of the first end and the second end of the elastic member 34 is limited, and a structure is more stable.

Alternatively, to make locking of the locking device 3 safer, the at least one locking hole 111 is a rectangular hole, and the locking head 33 is a protruding surface. The locking head 33 comprises a protruding part 331 and two buckling edges 332, and the two buckling edges 332 are buckled in the button 32. The protruding part 331 is disposed outside the button 32 and is configured to be inserted into the rectangular hole. Through the rectangular hole, the locking head 33 with a protruding surface can be inserted into the rectangular hole. Compared with a structure of a conventional circular locking hole, the rectangular hole can better lock the locking head 33, forming a more stable locking structure, which can avoid a phenomenon of the locking device 3 being disengaged and improve the safety performance of the ladder 1.

The above description represents only a preferred specific embodiment of the present disclosure and is not intended to limit its design concept. Any minor modifications made to the present disclosure based on this concept by those skilled in the art within the technical scope disclosed herein shall be deemed acts of infringing upon the protection scope of the present disclosure.

What is claimed is:

1. A ladder with a lifting and lowering handrail, comprising:
a ladder body, and
a handrail frame sleeve on the ladder body and configured to be lifted and lowered, wherein:
the ladder body comprises two front leg tubes, two rear leg tubes, and two pivoting sleeves,
the two front leg tubes and the two rear leg tubes are pivotally connected to form a foldable inverted Y-shaped structure,
the handrail frame comprises a lateral rod and two side rods symmetrically arranged on a left and right direction,
upper ends of the two side rods are connected to two ends of the lateral rod,
the two pivoting sleeves respectively cover tops of the two front leg tubes,
tops of the two rear leg tubes are respectively pivotally connected to the two pivoting sleeves,
cross sections of the two side rods are C-shaped cross sections,
C-shaped openings of the C-shaped cross sections are located on inner sides of the two side rods,
the C-shaped openings of the two side rods cover outer sides of the two front leg tubes,
the two pivoting sleeves comprise position-providing grooves,
the two side rods are configured to slide on the position-providing grooves,
a lower end of at least one of the two side rods is disposed with a locking device, and
the locking device is configured to be a lifting-and-lowering adjusting switch for controlling the handrail frame to be lifted and lowered.

2. The ladder with the lifting and lowering handrail according to claim 1, wherein:
an upper end surface of each of the two pivoting sleeves comprises a step surface,
outer sides of the two pivoting sleeves comprise the position-providing grooves, and
when the handrail frame is retracted, the lateral rod abuts the step surface.

3. The ladder with the lifting and lowering handrail according to claim 1, wherein:
each of the two pivoting sleeves comprises a first sleeve and a second sleeve,
the first sleeve is sleeved on a corresponding one of the two front leg tubes,
the second sleeve is sleeved on a corresponding one of the two rear leg tubes, and
the second sleeve comprises a space for the corresponding one of the two rear leg tubes to rotate.

4. The ladder with the lifting and lowering handrail according to claim 3, wherein:
the corresponding one of the two rear leg tubes is rotatably connected in the second sleeve through a rivet.

5. The ladder with the lifting and lowering handrail according to claim 1, wherein:
the locking device comprises a hand-held sleeve sleeved on the lower end of the at least one of the two side rods, a button pivotally connected to the hand-held sleeve, at least one locking hole arranged on a side of a corresponding one of the two front leg tubes, and a locking head disposed on the button and configured to correspond to the at least one locking hole, and
the locking head is configured to be disposed in or separated from the at least one locking hole driven by the button.

6. The ladder with the lifting and lowering handrail according to claim 5, wherein:
the hand-held sleeve is buckled to the at least one of the two side rods,
a middle part of the button is pivotally connected to the hand-held sleeve,
the button is located on a rear side of the hand-held sleeve,
the locking head is disposed on an inner side of a lower end of the button,
an elastic member is disposed on an inner side of an upper end of the button, and
the locking head is configured to be disposed in the at least one locking hole driven by the elastic member.

7. The ladder with the lifting and lowering handrail according to claim 5, wherein:
a part of the button that forms the locking head extends out of the hand-held sleeve and forms an interlocked connection with the at least one locking hole on the corresponding one of the two front leg tubes.

8. The ladder with the lifting and lowering handrail according to claim 5, wherein:
the at least one locking hole is at least one rectangular hole,
the locking head is a protruding surface,
the locking head comprises a protruding part and two buckling edges,
the two buckling edges are buckled in the button, and
the protruding part is disposed outside the button and is configured to be disposed in the at least one rectangular hole.

9. The ladder with the lifting and lowering handrail according to claim 5, wherein:
the at least one locking hole is a plurality of locking holes, and the plurality of locking holes are spaced apart along a length direction of the corresponding one of the two front leg tubes.

10. The ladder with the lifting and lowering handrail according to claim 1, wherein:
the handrail frame is U-shaped, and
the lower end of each of the two side rods is disposed with the locking device.
